(19) United States
(12) Patent Application Publication
(10) Pub. No.: US 2017/0337293 A1
(43) Pub. Date: Nov. 23, 2017

(54) SYSTEM AND METHOD OF RENDERING MULTI-VARIANT GRAPHS

(71) Applicant: Sisense Ltd., Tel-Aviv (IL)

(72) Inventors: Eldad FARKASH, Tel-Aviv (IL); Dean SHUB, Rishon LeZion (IL); Guy BOYANGU, Tel-Aviv (IL)

(21) Appl. No.: 15/158,197

(22) Filed: May 18, 2016

(51) Int. Cl. G06F 17/30

(52) U.S. Cl. CPC G06F 17/30958; G06F 17/30601

(57) ABSTRACT

The presently disclosed subject matter includes a computer-implemented method and system adapted for graphically visualizing both data and metadata in a single graph layout. The generated graph can be displayed on a computer display device to collectively show in a single graph, and in a visually appealing and comprehensive manner, both the data and metadata pertaining to the data object represented by a graph.

### FIELD OF THE PRESENTLY DISCLOSED SUBJECT MATTER

The presently disclosed subject matter relates to the field of computer-implemented graph layout display.

### BACKGROUND

Graphs are often used for the purpose of logically representing relations and processes in a large variety of fields of use such as computer science, biology, chemistry, physics, sociology, mathematics, statistics, decision theory, and others. Graphs are made up of nodes (otherwise known as vertices or points) and edges (otherwise known as arcs or lines) that connect between nodes. The node and edges provide together the structure of the graph. Nodes in a graph represent respective data objects and edges represent relations between data objects in the graph.

Graphs can be visually displayed in order to provide a pictorial representation of the information in the graph. The same graph, connecting a given set of nodes with a respective set of edges, can be displayed using various graph layouts, each layout providing a different arrangement of the nodes and edges in the graph in a multiple dimension space.

### GENERAL DESCRIPTION

The specific arrangement of the nodes and edges in a specific graph layout (the visual display of the graph) which is used, affects various aspects related to the graph, including its comprehensibility, computer resources consumption, and aesthetics. When a graph is being drawn and displayed it is often desired to choose a graph layout in favor of these aspects. However, as the graph grows in size, it becomes difficult to control the nodes and edges in the graph in order to obtain a desirable graph representation. One problem is related to the difficulty to draw a graph having a large number of nodes while avoiding drawing edges crossing one over the other and sometimes also over nodes, which makes the graph difficult to understand.

One known technique of automatic graph drawing is force-directed graph drawing, which is a class of algorithms for drawing graphs in an aesthetically pleasing way. The purpose of these algorithms is to position the nodes of a graph in a multiple dimensional space (e.g. two-dimensional or three-dimensional) so all the edges are of more or less equal length and there are as few crossing edges as possible. This is accomplished by applying graph drawing rules on the nodes and edges (referred to herein collectively as “graph elements”), which are derived from physical laws. For example, two physical laws which are used for this purpose are, Coulomb's law (defining repulsion between electrically charged particles, Fᵣ=k/d²) and Hooke's law (defining the forces working on a spring, Fₐ=−k/d). The application of these physical laws on the graph elements causes the graph elements to move into position and provide a graph layout according to the forces which act on the elements. Other examples of graph drawing algorithms include: spectral layout, layered graph drawing, circular layout, dominance drawing etc. (see for example https://en.wikipedia.org/wiki/Graph_drawing#Layout_methods).

Some examples of the presently disclosed subject matter suggest using graphs for displaying information in the field of business intelligence (BI). In this field of study, information from various data sources is brought together and transformed into comprehensive and meaningful data which can be used for data analytics purposes. Data warehousing is often used for this purpose.

The presently disclosed subject matter includes a computer-implemented method and system adapted for graphically visualizing both data and metadata in a single graph layout. The generated graph can be displayed on a computer display device to collectively show in a single graph, and in a visually appealing and comprehensive manner, both the data and metadata pertaining to the data object represented by the graph. The term display device is used to include any type of display device configured for displaying digital data including a computer screen, a smartphone screen, a television screen, etc.

According to one aspect of the presently disclosed subject matter there is provided a computer implemented method of generating a graph layout for collectively visualizing both graph data and graph metadata on a computer display device; the computer comprising at least one computer processor; the method comprising operating the at least one computer processor for:

obtaining an initial graph comprising two or more nodes, wherein at least two nodes in the initial graph are connected by an edge; wherein nodes in the initial graph represent respective data objects and have metadata associated therewith;

assigning each node in the initial graph to a respective category based on respective metadata values of the node; recording the number of each different type of diverse node-pair and deleting edges between diverse node pairs; wherein a diverse node pair includes two connected nodes, each node assigned to a different category; generating a cluster graph; the cluster graph comprising a cluster node for each category of nodes in the diverse-node pairs and an edge connecting any two cluster nodes representing a respective diverse node pair; generating a cluster sub-graph connecting all nodes in the initial graph which are assigned to the same category; assigning each cluster sub-graph to a respective cluster node in the cluster graph; applying a graph drawing algorithm on each cluster sub-graph; rendering a final graph comprising the cluster graph and a cluster sub-graph within each respective cluster node of the cluster graph; wherein cluster nodes graphically indicate respective metadata and nodes in each cluster sub-graph graphically indicate respective data.

In addition to the above features, the method according to this aspect of the presently disclosed subject matter can optionally comprise one or more of features (i) to (xviii) below, in any technically possible combination or permutation:

(i). The method further comprising applying a graph drawing algorithm on the cluster graph.

(ii). wherein generating a cluster sub-graph comprises:

adding virtual edges connecting between all nodes assigned to the same category for facilitating the application of the graph drawing algorithm on the respective cluster sub-graph.

(iii). wherein the virtual edges are not displayed on the displayed device and remain hidden from the eyes of the user.

(iv). wherein rendering a final graph comprises:

iteratively applying the graph drawing algorithm on each cluster sub-graph, and for each iteration:

determining distance between two most distanced nodes in each cluster sub-graph; and

updating perimeter of a respective cluster node based on the distance.

(v). wherein rendering the final graph further comprises:

applying linear transformation for transforming the graph layout of each cluster sub-graph resulting from the graph drawing algorithm to a respective graph layout adapted to the world confined by the perimeter of a respective cluster node.

(vi). wherein determining distance between two most distanced nodes in each cluster sub-graph comprises applying a minimum spanning tree algorithm on the cluster sub-graph.

(vii). wherein the graph drawing algorithm is a force directed graph algorithm.

(viii). The method further comprising displaying the final graph on a computer display device.

(ix). wherein rendering the final graph comprises: graphic visualization with respect to an edge connecting two cluster nodes, information pertaining to the number of diverse node pairs.

(x). wherein rendering the final graph comprises: rendering each cluster node using one or more graphic design elements to indicate the respective metadata category of the cluster node.

(xi). wherein the one or more graphic design elements includes one or more of: color of cluster node, size of cluster node, shape of cluster node, texture of cluster node; and graphical display of a metadata value.

(xii). wherein each node in each cluster sub-graph is linked to a respective data object, the method further comprising: graphically displaying data pertaining to the respective data object responsive to user interaction with the given node.

(xiii). The method further comprising:

for each iteration updating the cluster graph and the cluster sub-graph in each cluster node and graphically displaying on a computer display the updated cluster graph and updated cluster sub-graphs thereby visualizing in real-time changes to the cluster graph until it reaches a state of the final graph.

(xiv). wherein an addition or a deletion of a node from the final graph involves application of operation only with respect to a restricted area of the final graph.

(xv). Wherein the restricted area comprises: a respective cluster sub-graph to which the node is related, a cluster node comprising the respective cluster sub-graph and any cluster node immediately connected to the cluster node; thereby limiting performance degradation resulting from addition or deletion of a node.

(xvi). wherein adding a new node to the graph comprises:

assigning the new node to a respective category;

connecting the new node to an existing cluster sub-graph of the respective category;

applying a graph drawing algorithm to a restricted area of the graph comprising the existing cluster sub-graph; a respective cluster node of the existing cluster sub-graph; and to cluster nodes immediately connected to the respective cluster node.

(xvii). wherein the metadata pertains to a plurality of metadata types, the method comprising calculating a compiled metadata value based on the values of the plurality of metadata types.

(xviii). wherein the data object is a table comprising business intelligence information.

According to another aspect of the presently disclosed subject matter there is provided a non-transitory program storage device readable by machine, tangibly embodying a program of instructions executable by the machine to perform method of generating a graph layout for collectively visualizing both graph data and graph metadata on a computer display device; the computer comprising at least one computer processor; the method comprising:

obtaining an initial graph comprising two or more nodes, wherein at least two nodes in the initial graph are connected by an edge; wherein nodes in the initial graph represent respective data objects and have metadata associated therewith;

assigning each node in the initial graph to a respective category based on respective metadata values of the node;

recording the number of each different type of diverse node-pair and deleting edges between diverse node pairs; wherein a diverse node pair includes two connected nodes, each node assigned to a different category;

generating a cluster-graph; the cluster graph comprising a cluster node for each category of nodes in the diverse-node pairs and an edge connecting any two cluster nodes representing a respective diverse node pair; generating a cluster sub-graph connecting all nodes in the initial graph which are assigned to the same category;

assigning each cluster sub-graph to a respective cluster node in the cluster graph;

applying a graph drawing algorithm on each cluster sub-graph;

rendering a final graph comprising the cluster graph and a cluster sub-graph within each respective cluster node of the cluster graph; wherein cluster nodes graphically indicate respective metadata and nodes in each cluster sub-graph graphically indicate respective data.

In addition to the above features, the program storage device according to this aspect of the presently disclosed subject matter can optionally comprise one or more of features (i) to (xviii) above, in any technically possible combination or permutation.

According to another aspect of the presently disclosed subject matter there is provided a computer-implemented system of generating a graph layout for collectively visualizing both graph data and graph metadata on a computer display device; the system comprising at least one computer processor operatively connected to a computer memory; the at least one computer processor being configured, responsive to instructions loaded on the computer memory, to:

assign each node in an initial graph to a respective category based on respective metadata values of the node; wherein the initial graph comprises two or more nodes, wherein at least two nodes in the initial graph are connected by an edge; wherein nodes in the initial graph represent respective data objects and have metadata associated therewith;

record the number of each different type of diverse node-pair and deleting edges between diverse node pairs; wherein a diverse node pair includes two connected nodes, each node assigned to a different category;

generate a cluster-graph; the cluster graph comprising a cluster node for each category of nodes in the diverse-node pairs and an edge connecting any two cluster nodes representing a respective diverse node pair; generate a cluster sub-graph connecting all nodes in the initial graph which are assigned to the same category;

assign each cluster sub-graph to a respective cluster node in the cluster graph;

apply a graph drawing algorithm on each cluster sub-graph;

render a final graph comprising the cluster graph and a cluster sub-graph within each respective cluster node of the cluster graph; wherein cluster nodes graphically indicate respective metadata and nodes in each cluster sub-graph graphically indicate respective data.

The presently disclosed subject matter further contemplates a data warehouse system configured for generating and rendering a multi-variant graph as disclosed herein.

In addition to the above features, the system according to the above aspects of the presently disclosed subject matter can optionally comprise one or more of features (i) to (xviii) above, in any technically possible combination or permutation.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is function block diagram of data warehouse system 100 according to some examples of the presently disclosed subject matter;

FIG. 2 is a flowchart illustrating operations performed according to some examples of the presently disclosed subject matter;

FIG. 3 is a screenshot of a graphical user interface displaying different tables imported from one or more data sources, according to some examples of the presently disclosed subject matter;

FIG. 4 is a screenshot of a graphical user interface displaying tables imported from one or more data sources and connecting lines indicating relationships between different tables, according to some examples of the presently disclosed subject matter;

FIG. 5 is a screenshot showing a graphical user interface displaying graph layout resulting from the execution of a graph layout transformation process, according to some examples of the presently disclosed subject matter;

FIG. 6 is a screenshot showing a graphical user interface displaying multi-variant graph layout, according to some examples of the presently disclosed subject matter;

FIG. 7 is a functional block diagram of data management unit 105, according to some examples of the presently disclosed subject matter;

FIG. 8 is a flowchart illustrating operations performed as part of generation and rendering of a multi-variant graph layout, according to some examples of the presently disclosed subject matter;

FIG. 9 is a schematic illustration of an example of an initial graph, according to some examples of the presently disclosed subject matter;

FIG. 10 is a schematic illustration showing the initial graph and the respective diverse node-pairs count, according to some examples of the presently disclosed subject matter;

FIG. 11 a schematic illustration showing the initial graph with deleted edges connecting between diverse node-pairs, according to some examples of the presently disclosed subject matter;

FIG. 12 a schematic illustration showing the initial graph and the respective cluster graph, according to some examples of the presently disclosed subject matter;

FIG. 13 is a schematic illustration showing connections created between nodes in the same sub-group, according to some examples of the presently disclosed subject matter;

FIG. 14 is a schematic illustration showing an intermediate graph layout, according to some examples of the presently disclosed subject matter;

FIG. 15 is a schematic illustration showing the final graph layout, according to some examples of the presently disclosed subject matter;

FIG. 16 is a flowchart illustrating operations performed during the addition of a node to the final graph, according to some examples of the presently disclosed subject matter;

FIG. 17 is a schematic illustration showing a final (multi-variant) graph layout and connections to a new node, according to some examples of the presently disclosed subject matter;

FIG. 18 is a schematic illustration showing a final (multi-variant) graph layout after edges to a new node were deleted, according to some examples of the presently disclosed subject matter;

FIG. 19 is a schematic illustration showing a final (multi-variant) graph layout and with the added new cluster graph, according to some examples of the presently disclosed subject matter;

FIG. 20 is a schematic illustration showing a final (multi-variant) graph layout and connections to a new node, according to some examples of the presently disclosed subject matter;

FIG. 21 is a schematic illustration showing a final (multi-variant) graph layout, after edge of a diverse pair was deleted, according to some examples of the presently disclosed subject matter; and

FIG. 22 is a schematic illustration showing the final (multi-variant) graph layout after incorporation of the new node to the relevant cluster node, according to some examples of the presently disclosed subject matter.

### DETAILED DESCRIPTION

In the drawings and descriptions set forth, identical reference numerals indicate those components that are common to different embodiments or configurations. Elements in the drawings are not necessarily drawn to scale.

Unless specifically stated otherwise, as apparent from the following discussions, it is appreciated that throughout the specification discussions utilizing terms such as “obtaining”, “assigning”, “recording”, “generating”, “applying”, “rendering”, “displaying” or the like, include action and/or processes of a computer that manipulate and/or transform data into other data, said data represented as physical quantities, e.g. such as electronic quantities, and/or said data representing the physical objects.

System 100 and data management unit 105 described below are computerized devices comprising or otherwise operatively connected to at least one computer processing device configured for executing various operations as described below. The terms “computerized device”, “computer”, “computer processing device”, “processing device”, or variations thereof should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and\or any combination thereof.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiments) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

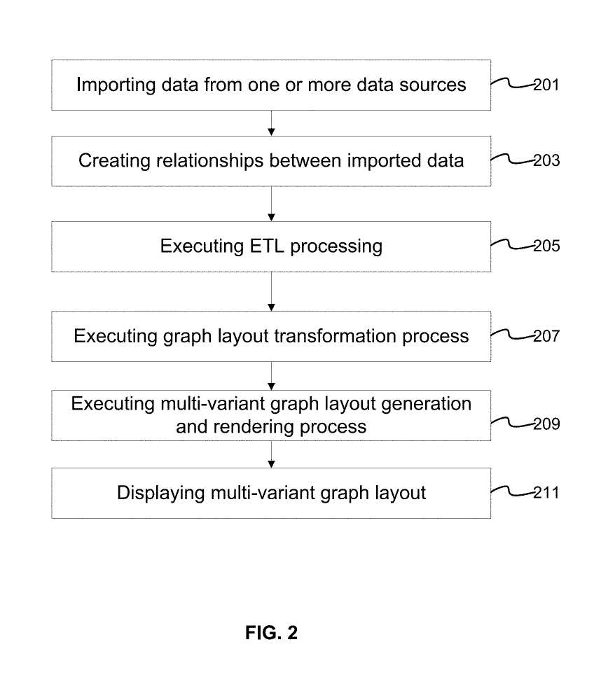

In embodiments of the presently disclosed subject matter, fewer, more and/or different stages than those shown in FIGS. 2, 8 and 16 may be executed. In embodiments of the presently disclosed subject matter one or more stages illustrated in FIGS. 2, 8 and 16 may be executed in a different order and/or one or more groups of stages may be executed simultaneously. For example, in some cases, generation of the cluster graph mentioned below with reference to block 807 can be executed after, or at the same time category sub-graphs are generated, as described below with reference to block 809. It should be understood that the presently disclosed subject matter contemplates any combination of operations which are described separately with reference to any one of FIGS. 2, 8 and 16 into a single unified process.

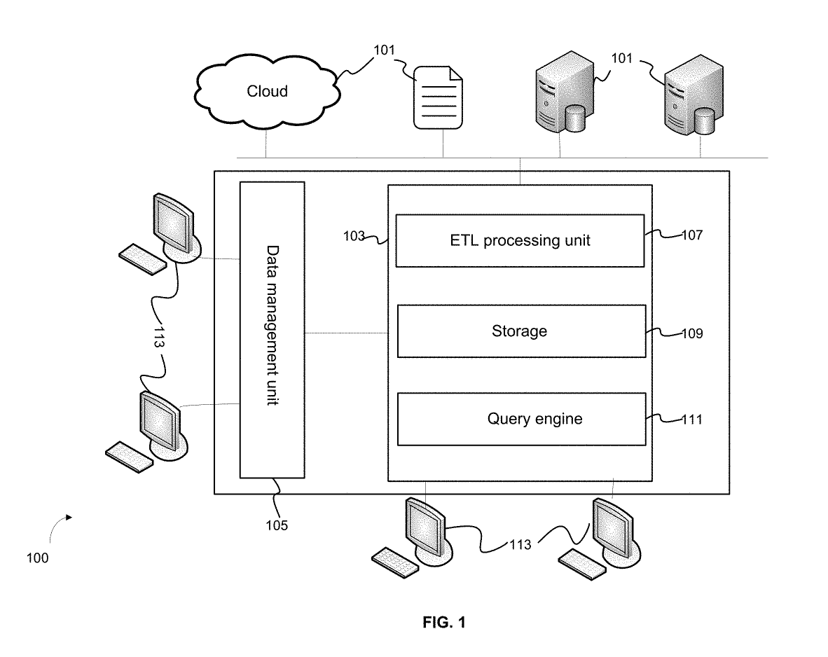

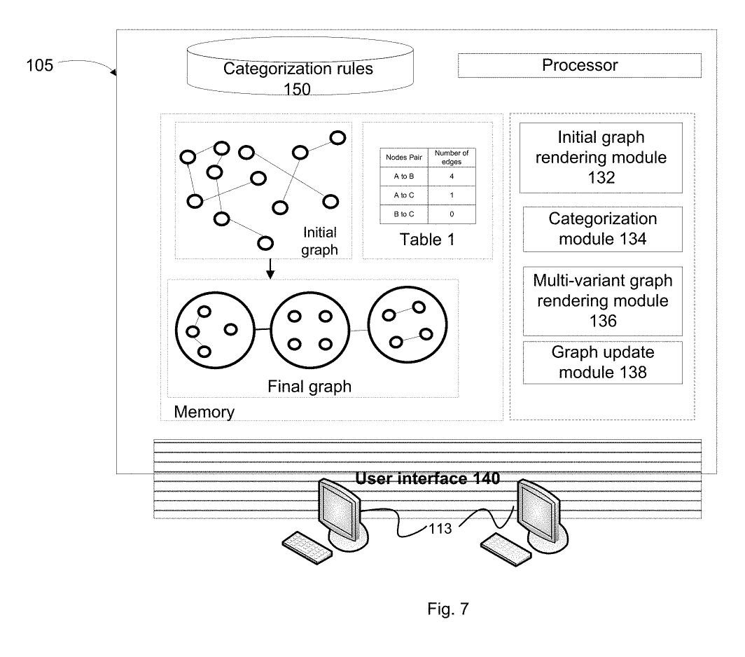

Functional elements in FIGS. 1 and 7 may be centralized in one location or distributed over more than one location. It is noted that the teachings of the presently disclosed subject matter are not bound by the specific structure described with reference to FIGS. 1 and 7. Equivalent and/or modified functionality can be consolidated or divided in another manner (can be implemented as centralized or distributed systems) and can be implemented in any appropriate combination of software with firmware and/or hardware and executed on a suitable device. For example, division of data management unit 105 in FIG. 7 into the specified functional elements is done for the sake of example only and should not be construed as limiting in any way. In other examples, functional elements can be divided differently than shown in the illustration.

Bearing the above in mind, attention is now drawn to FIG. 1 which is a functional block diagram schematically illustrating a database warehouse system 100, according to some examples of the presently disclosed subject matter. Data warehouse system 100 is a computer system comprising one or more computerized devices.

In general a data warehouse is single database, where information from various data sources is collected and stored for providing a consolidated information resource. The process of collecting and storing the data in a data warehouse is commonly known as an extract, transform, load process (ETL). Data warehouse system 100 can comprise for example a data warehouse processing layer 103 which comprises in turn, ETL processing unit 107, data storage unit 109 and query engine 111. ETL processing unit 107 is configured, responsive to received instructions, to import data from various data sources 101. According to one example, following an import command, ETL processing unit 107 is configured to execute ETL operations including data extraction, data transformation and data loading.

During extraction, data is identified and extracted from one or more sources 101. Data sources can include for example database systems (e.g. other data warehouse system, Enterprise Resource Planning (ERP) systems, Customer Relationship Management (CRM) systems, etc.), flat files, Microsoft Excel files, Microsoft Access files, cloud storage resources, various applications, etc. The extracted data is then physically transported to ETL processing unit 107 in data warehouse system 100.

Depending on the specific type of data warehouse system, transformation occurs during and/or after extraction. During transformation, data originating from homogeneous or heterogeneous data sources is converted into a consistent format. Problems such as inconsistencies among units of measure and naming conflicts are resolved. The transformed data is loaded into the final target database warehouse. The final warehouse database is stored in a storage device (e.g. storage device 109 in ETL processing unit 107).

Data warehouse system 100 further comprises query engine 111. A query engine enables to execute queries on the final data stored in the database warehouse, and provide information pertaining to data from all sources. The query engine includes a user interface visualized on a display device of a user computerized device 113 for enabling users to input their queries and view query results.

According to the presently disclosed subject matter, data warehouse system 100 comprises data management unit 105 operatively connected to data warehouse processing layer 103. Data management unit 105 is configured to provide a visualized environment where a user (e.g. a system administrator) can perform various operations for preparing data for analysis and visualization.

As shown in more detail below, data management unit 105 can comprise a user interface which can be displayed on a display device of a user computerized device 113 for providing a visualized and interactive working environment which enables system users to view and manipulate data.

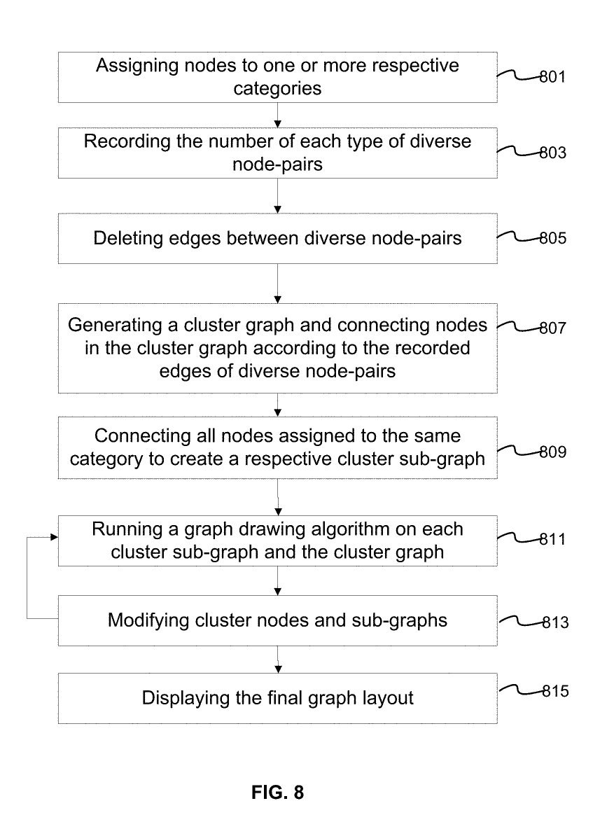

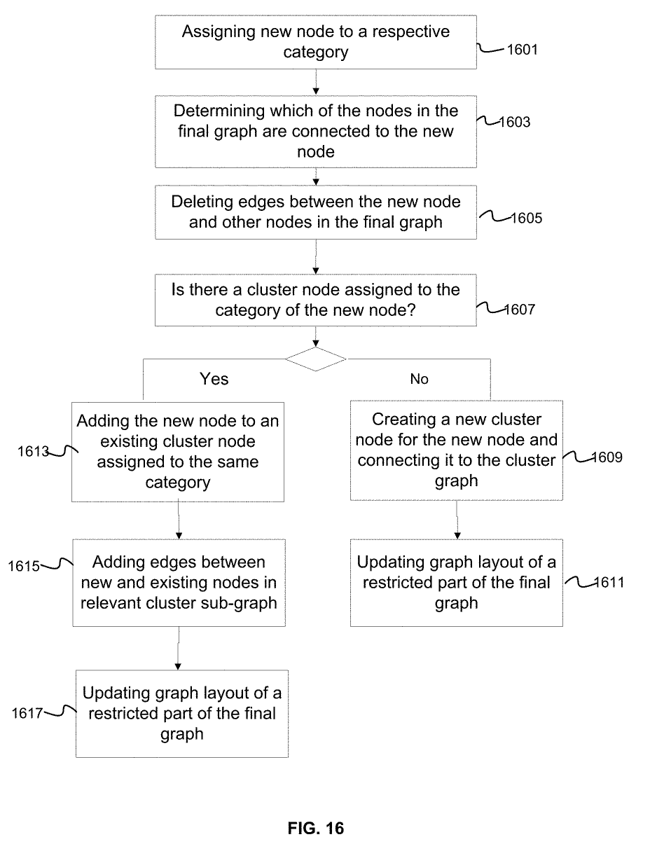

FIG. 2 is a flowchart illustrating operations performed according to some examples of the presently disclosed subject matter. Operations described below with reference to FIG. 2 (as well as FIGS. 8 and 16) can be executed for example by data management unit 105 constructed for operating according to the principles described herein.

As explained above, according to the presently disclosed subject matter it is suggested to use graphs for displaying data including for example, business intelligence (BI) data, extracted from data resources (e.g. data warehouses) for data analytics purposes. With the help of data management unit 105 data can be imported and processed to be graphically visualized in a desired graph layout.

At block 201 data is imported from various data sources to the graphical user interface. As explained above, data management unit 105 is configured to enable importing data to a graphical user interface created by data management unit 105. For example, a user can interact with data management unit 105 via user computer device 113 (using for example a computer mouse and keyboard and graphical user interface displayed on device 113) and generate instructions for importing data from one or more data sources which are made available for this purpose. The user can be provided with access to the different data sources 101 and select the desired data e.g. by drag and drop operations.

According to one non-limiting example pertaining to BI data analysis, data objects imported from the various data sources 101 include tables comprising one or more columns. According to one possible approach, tables are displayed in the graphical user interface as squares and their respective fields are displayed as rectangles within the tables. Commonly each row within the tables comprises at least one data identifier for uniquely identifying the described objects in the table and one or more other fields representing various data attributes characterizing a respective described object.

Data objects are not limited to tables and in other examples data objects can represent other types of stored information including: images obtained from image databases, personal profiles obtained from a social network database, computers obtained from a server farm database, books obtained from a library database and so forth. It should be noted that any reference or example made herein with respect to BI and/or tables is made by way of example only and should not be construed as limiting in any way. Relationships between data objects other than tables can be made based on some common attribute. For example, data objects representing books from a library database can be connected based on common author or common genre or common year of publication, etc.

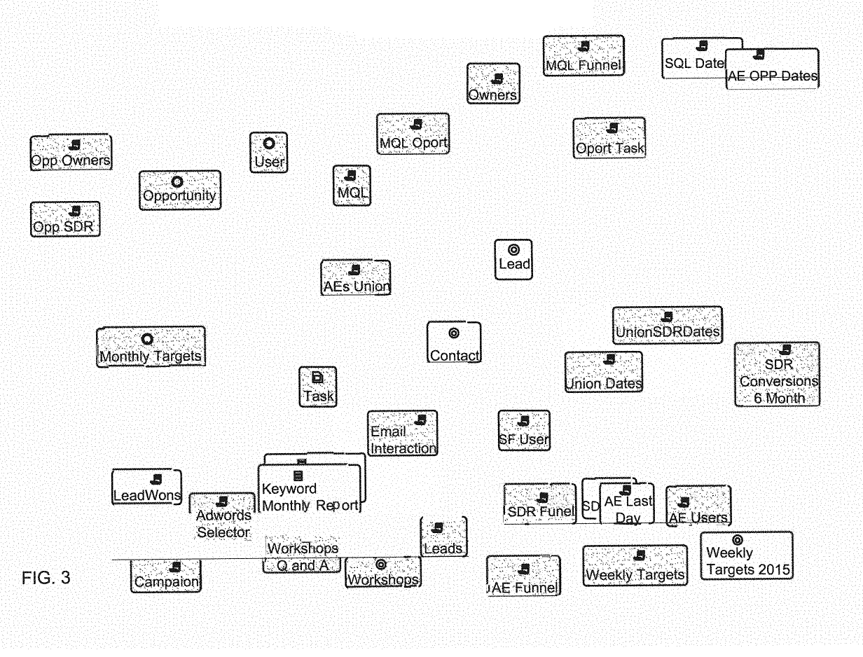

Turning to FIG. 3 it shows a screenshot of the graphical user interface displaying different tables selected to be imported from one or more data sources, according to some examples of the presently disclosed subject matter.

Data management unit 105 provides a user with the capability to create relationships between different tables (block 203). Relationships can be created for example by dragging or drawing connecting lines (for creating “connections”) between different data objects (e.g. tables). Fields which are visualized within the tables simplify creating new connections between fields in different tables. The user can also move the tables around and change their relative position on the screen before and/or after the connecting lines are added.

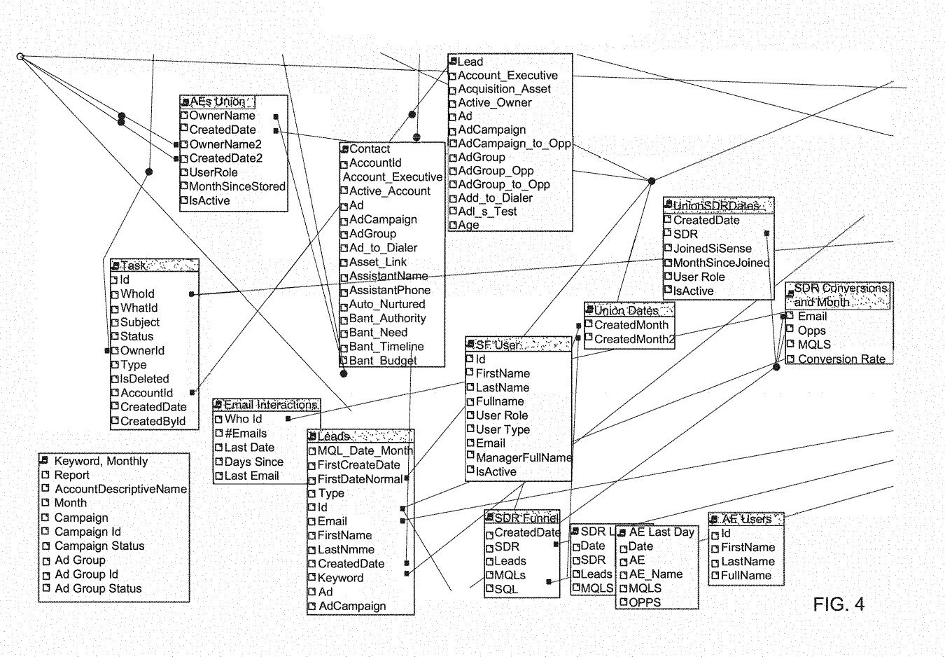

FIG. 4 is a screenshot of the graphical user interface displaying different tables selected to be imported from one or more data sources and the connecting lines indicating relationships between different tables, according to some examples of the presently disclosed subject matter.

At block 205 ETL processes are executed on the connected tables. The selected tables are extracted from the relevant data sources and imported by data management unit 105. The imported data can be stored for example in storage 109. Relationship between imported tables can be made between tables comprising overlapping object identifiers. Conflicting names in different tables are resolved as part of the ETL process to enable correspondence between values in connected tables.

The collection of tables and their respective connections represent collectively a kind of customized database created by the user. Data management unit 105 therefore provides a flexible (elastic) working environment which allows the user to create “customized databases” by importing data objects (e.g. in the form of tables), visualizing the imported data object in a graphical user interface, and creating and visualizing relationships between tables.

At block 207 a graph layout transformation process is executed on the customized database. During this process tables in the customized database are transformed into nodes in a graph and connecting lines between the tables are transformed into edges. Graph layout transformation process can further include drawing a graph representing the customized database. In some examples, the graph layout transformation process can be executed as part of the ETL process.

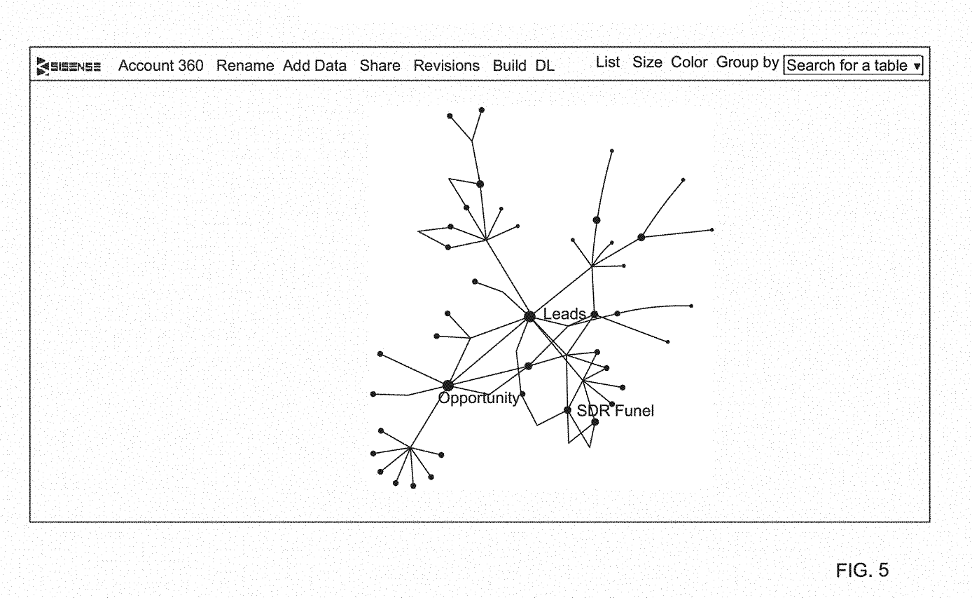

Optionally, once the customized database is transformed and represented by a graph, the graph display layout can be managed using graph drawing algorithms such as the force-directed graph mentioned above. FIG. 5 is a screenshot showing an example of the graphical user interface displaying a graph layout resulting from the execution of a graph layout transformation process.

It is sometimes desired to categorize data object (e.g. tables) represented in the customized database into specific categories. Data objects can be categorized based on metadata which can be associated with the data objects. Metadata can describe the data of a data object. Metadata can also describe the data object itself. Metadata of a given data object can be linked in some way to the data object and be retrievable from a data source (101) together with the data object.

For example, tables of a BI database can be categorized based on various table metadata (stored as auxiliary information in addition to the data within the table), which characterize the tables independently of the specific values stored within them. Table metadata can include for example various metadata types, such as: type of table data source (MySql, Oracle, MS-sql, MongoDB, etc.); number of fields and/or rows in each table; table usage statistics; time from last access request made to each table; hard-disk storage space consumption of each table; time of last change made in each table; identifier of the user who changed a table; and so forth.

Other types of data objects can also be associated with respective metadata describing the data. For example, in addition to images, representing the data, an image database can include metadata characterizing the images. Image database metadata can include for example, image theme or title, image resolution, black and white or colored image, image source and/or photographer, image size in bytes, etc.

In the BI example, tables in the customized database can be categorized based on their respective metadata values and in some cases based on a mix of a plurality of metadata values. By doing so, valuable information pertaining to the imported data, used for constructing the customized database, becomes apparent to the user. This type of categorization helps users to make intelligent choices about their data. For examples, tables in the graph can be divided into categories based on their usage statistics (e.g. number of access requests made to each table in the last week) or disk space consumption values, where different ranges of values are assigned to a different category. Making frequently used tables stand out and categorizing these tables based on disk space consumption, can assist in the management of the stored information.

Assigning data objects (e.g. tables), represented by nodes in a graph, to specific categories, can have a major effect on the visualization of the graph. According to the presently disclosed subject matter, it is desired, when graphically displaying (on a computer display device) the categorization of the tables in the graph, to move tables in the graph which are assigned to the same category, such that they are positioned close together to other tables of the same category. This allows viewing nodes assigned to the same category together as one group of nodes, and thereby graphically and collectively visualizing information pertaining to both the data and metadata of the graph.

However, shifting nodes into the assigned groups based on their categories may destroy any previously obtained graph layout and result in a generally disordered graph layout characterized, for example, by a substantial increase in the number of crossing edges.

Thus, attempting to graphically display categorization of data objects in a graph using known graph layout techniques may provide poor results which do not provide the desired comprehensibility and aesthetics, and in some cases cause significant performance degradation to the system. As the graph grows in size, the resulting representation of the original graph layout, as well as the categorization, may become very difficult to understand and in some cases may even become completely incomprehensible.

At block 209 a multi-variant graph layout generation and rendering process is executed on the customized database to visualize both data and metadata of the tables. The disclosed graph layout mechanism provides graph visualization which remains comprehensible notwithstanding its multi-variant character. A more detailed description of operations involved in a multi-variant graph layout generation and rendering process is described below with reference to FIG. 8. The term “multi-variant graph” is used herein to include a graph having a layout that visualizes both data and metadata of data objects.

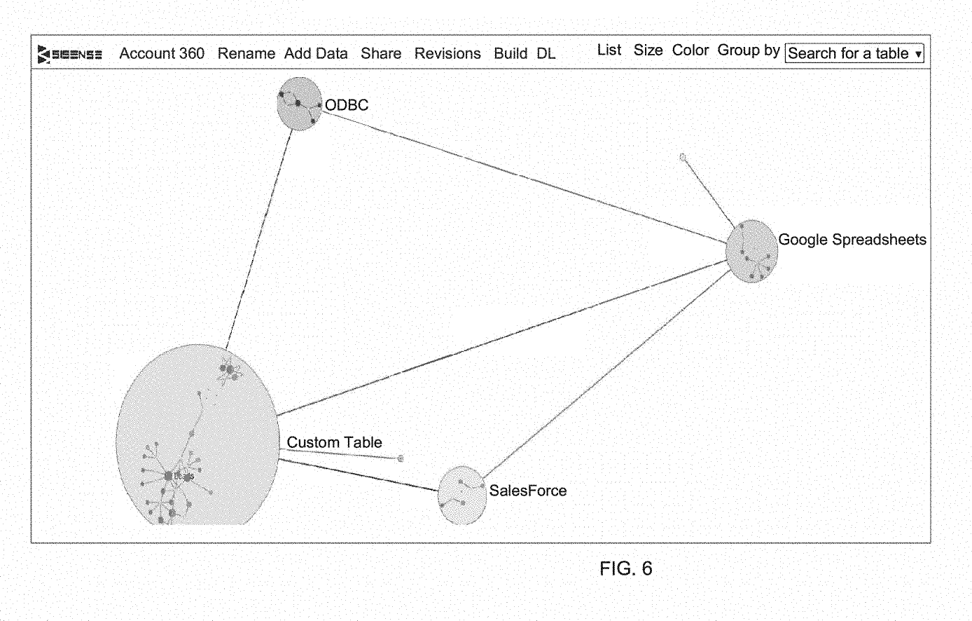

FIG. 6 is a screenshot showing the graphical user interface displaying multi-variant graph layout, according to some examples of the presently disclosed subject matter. As explained in more detail below, each large circle in the multi-variants graph represents a respective category of a certain metadata type, and contains within nodes assigned to that category. Each node represents a respective data object (e.g. table). At block 211 the generated graph is displayed on a display device (e.g. on the display device of user computer devices 113).

Turning to FIG. 7 it shows a functional block diagram of data management unit 105, according to some examples of the presently disclosed subject matter. Elements in FIG. 7 are described with reference to FIG. 8 below. FIG. 8 is a flowchart illustrating operations performed during the generation and rendering of multi-variant graph layout, according to some examples of the presently disclosed subject matter.

As explained above, after a user has imported the desired data objects (e.g. tables) and added connections between the data objects to create a customized database, the data objects in the customized database are transformed into graph nodes and the connections between the data objects are transformed into graph edges to obtain a graph structure. This graph is referred to herein below as an “initial graph”. According to the presently disclosed subject matter, the initial graph is further processed to be transformed into a multi-variant graph representing both data and metadata of the data objects. Notably, an “initial graph” is not limited to a graph generated in a data warehouse environment and includes graphs generated otherwise which comprise nodes representing data object characterized by data and metadata.

According to one example, data management unit 105 comprises initial graph rendering module 130, configured to execute the graph layout transformation process described with reference to block 207. As mentioned above, a user can interact with data management unit 105 via a user computer device 113 and user interface 140 (which can be executed locally on device 113 or remotely one device 105) and provide instructions for importing tables from one or more data sources, create connections between tables, and generate instructions to execute the process of generating and rendering the initial graph.

At block 801 nodes in the initial graph are assigned to respective categories. Assignment of nodes to categories can be executed for example by applying predetermined categorization rules on the metadata of the data objects represented by nodes in the initial graph. Categorization rules define the division of a metadata type into categories based on the respective metadata type values. According to one example, categorization module 132 in data management unit 105 can be configured to retrieve a respective value of a metadata data type of each given data object (e.g. table) and assign the node to a respective category based on the retrieved value according to the categorization rules.

For example, in case the metadata type pertains to the storage space consumption of each table, categorization rule can define association between different ranges of values of storage space consumed by a table, and respective categories. For instance, a first category is assigned to a first range of storage space consumption values (0 to n bytes), a second category is assigned to a second range of storage space consumption values (n+1 to m bytes) and so forth. Categorization rules can be stored for example in data-repository 150 being operatively connected to data management unit 105.

The specific metadata types which are used for the categorization process can be selected by the user or can be predetermined (e.g. according to some predefined default selection or policy). For example, a user can be provided with a list of available metadata types and select one or more metadata types that he wishes to display in the multi-variant graph.

When categorizing data in the customized database according to multiple categories, a collection of metadata values, each pertaining to a different category type, can be compiled to create a single value indicative of a customized category type. For example, assuming it is desired to create a customized category of type “data relevancy” indicating the relevancy of the data in each table to the needs of a certain user. This category can be made from a compilation of a number of categories selected by the user. For example, the data relevancy category can be based on the following parameters: number of changes in the data of a given table T, number of rows in the given table T, and disk space consumption of the given table T. Furthermore, in order to create a single value, various mathematical operations can be used on the collection of data. For example, the following formula can be used: (number of changes in the data+number of rows in the table)*disk space consumption of table. The value of the mathematical formula provides a compiled category value.

The rules (defined for example by a set of mathematical operations) for calculating a compiled metadata value from two or more existing metadata values can be provided as part of the categorization rules stored in the data storage. Categorization module 134 can be configured to execute the calculation of a compiled metadata responsive to instructions executed according to a preprogrammed policy or instructions received from an external source (e.g. from a user).

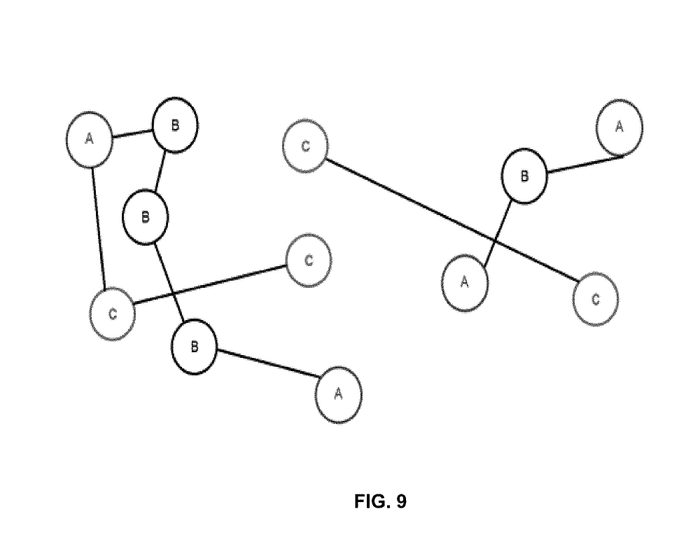

FIG. 9 is a schematic illustration of an example of an initial graph. In the illustrated example, each node in the graph represents a respective table and each edge represents a respective connection between tables. In this example each one of the nodes is assigned to one of three categories A, B and C. Notably, the illustrated graph comprises a number of uniform node-pairs and a number of diverse node-pairs. The term “uniform node-pair” refers to two nodes connected by an edge where both nodes are assigned to the same category of a given metadata type. The term “diverse node-pair” refers to two nodes connected by an edge where each node is assigned to a different category of a given metadata type.

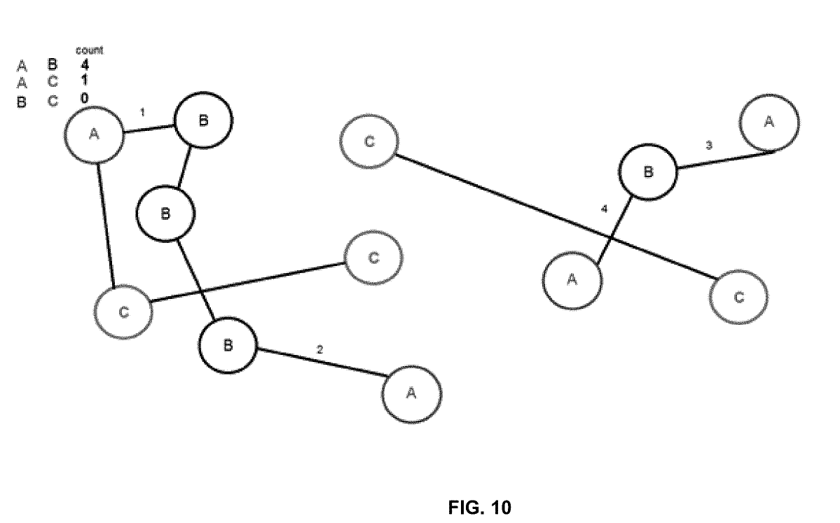

According to one example, operations described herein below with reference to blocks 803-813 can be executed by multi-variant graph rendering module 136. At block 803, the number of occurrences of each type of diverse node-pair is recorded. For example, multi-variant graph rendering module 136 in data management unit 105 can be configured to generate a data-structure comprising an entry for each type of diverse node-pair and record in the data-structure the number of occurrences of such node pairs in the graph. This data structure is exemplified by table 1 loaded to the computer memory of data management unit 105, which is illustrated in FIG. 7. For ease of understanding, the diverse node-pairs count is also denoted on the top left corner of FIGS. 10 to 12. Evidently, in the illustrated graph there are three possible types of diverse node-pairs: A to B; A to C; and B to C. FIG. 10 shows 4 A to B node-pairs, 1 A to C node-pair, and 0 B to C node-pair.

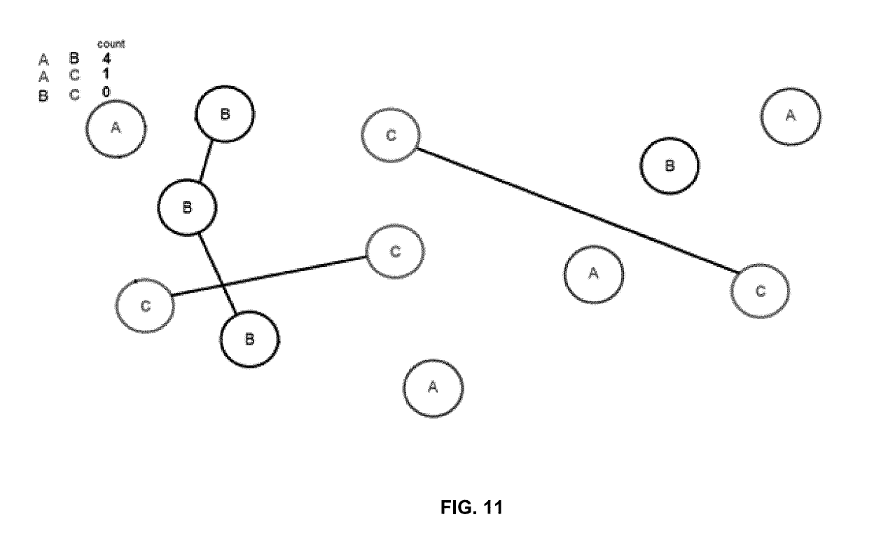

Once the diverse node-pairs have been recorded, edges connecting the diverse node-pairs are deleted from the initial graph (block 805). This is schematically illustrated in FIG. 11 where all lines connecting between A to B node-pairs and A to C node-pairs, have been removed from the graph.

At block 807 a new graph is generated (referred herein as “cluster graph”). The cluster graph 1201 comprises one node for each category observed earlier in the diverse node-pairs. For example, multi-variant graph rendering module 136 can be configured to extract this information from table 1 generated earlier. Nodes in the cluster graph are referred herein below as “cluster nodes”.

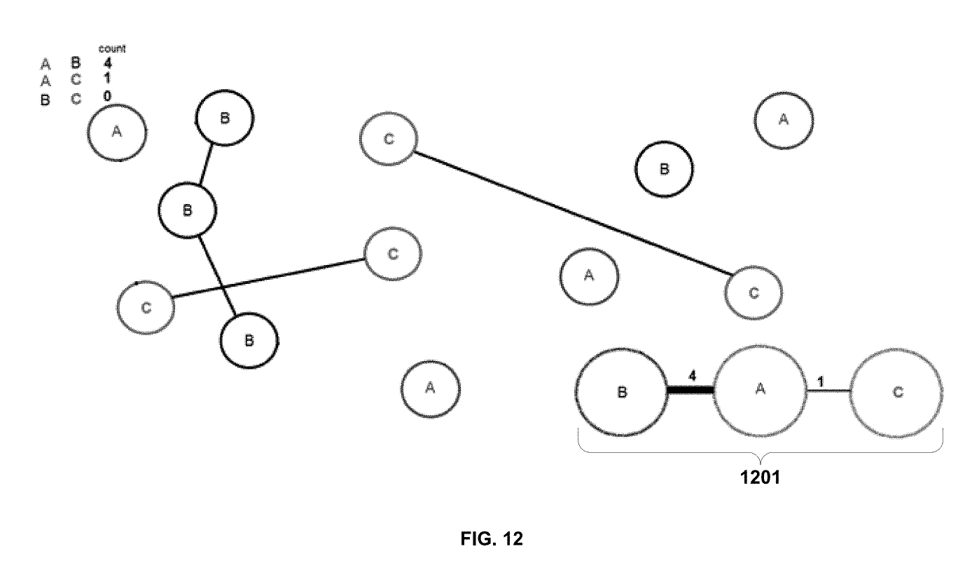

In the current example there are only two types of diverse node-pairs, A to B (4 connections) and A to C (1 connection). As illustrated in FIG. 12, in this case cluster graph 1201 comprises three nodes for categories A, B and C. Connections between cluster nodes are made according to the types of recorded diverse node-pairs. Accordingly, one node assigned to category A is connected to a second node assigned to category B and to a third node assigned to category C. Notably, according to one example, at this point the cluster graph is not displayed to the user. This is so, since at this stage the cluster nodes have only been generated and are currently empty.

As the connections between diverse node-pairs were deleted, the initial graph now comprises only connections between uniform node-pairs. Sub-groups of nodes assigned to each category (herein “category sub-group”) can be identified in the initial graph. Each category sub-group can include individual nodes and category sub-graphs, which are sub-graphs connecting nodes assigned to the same category.

Reverting to the example in FIG. 11, sub-group of category A has four unconnected nodes; sub-group of category B has one sub-graph comprising three connected nodes and one unconnected node; and sub-group of category C has two category sub-graphs, each comprising two connected nodes. According to one example, this information can be extracted and recorded by categorization module 134.

At block 809 all nodes in the same category sub-group are connected together to create a respective cluster sub-graph. Each cluster sub-graph of a certain category is assigned to a respective cluster node in the cluster graph.

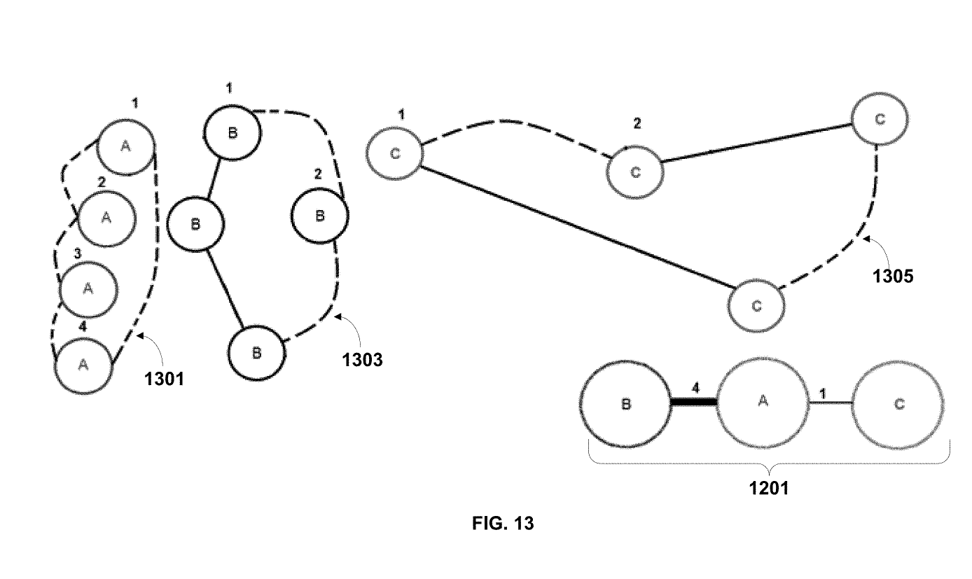

FIG. 13 is a schematic illustration of the connections created between nodes in the same category sub-group. New connections are shown by broken lines (referred to herein also as “virtual edges”). As illustrated in FIG. 13 all category sub-graphs are connected together to a single cluster sub-graph (cluster sub-graphs are indicated in FIG. 13 by 1301, 1303, and 1305). For example, in cluster sub-graph 1301 all category sub-graphs (each comprising a single node) are connected together. The new connecting lines are added in order to obtain a single graph for each category and enable the execution of a graph drawing algorithm on each cluster sub-graph. The new connecting lines are added by the system and not by the user, they do not represent logical relationships between nodes, and their utility is restricted to the drawing of the graph (and accordingly are named “virtual edges”). Thus, according to one example, these virtual edges are not displayed on the display device and remain hidden from the user.

During the generation of the cluster sub-graphs it is desired to identify, in each given category sub-graph, the two most distanced nodes and connect these nodes with the distanced nodes in another category sub-graph of the same category. The two distanced nodes in a graph (or sub-graph) are two nodes that the smallest set of edges (i.e. set of edges having the smallest value) connecting between them is greater than (or equal to) any other set of edges connecting between any other pair of nodes in the graph. As the identification of the distanced nodes in a given category sub-graph is an NP hard problem, according to one example an alternative technique is disclosed herein where a minimum spanning tree algorithm is executed on each category sub-graph to obtain a spanning tree connecting all nodes in the category sub-graph with a minimal total weighing for its edges. For this purpose each edge can be assigned with the same value (e.g. value of 1) and the set of edges with the smallest cumulative value is identified.

Two leafs of the obtained spanning tree are connected to unconnected nodes in another category sub-graph of the same category to create a closed circle and thereby generating a graph connecting together all nodes assigned to the same category (“cluster sub-graph”). Notably, a minimal spanning tree algorithm may identify more than two leaf nodes. It has been found by the Applicant that using any two of the identified leaf nodes as the two most distanced nodes in a category sub-graph as disclosed herein, provides a good approximation of distanced nodes.

Algorithms directed for finding a minimum spanning tree are well known in the art, see for example, Eisner, Jason (1997). State-of-the-art algorithms for minimum spanning trees: A tutorial discussion. Manuscript, University of Pennsylvania, April. 78 pp.

According to some examples, graph drawing algorithm (e.g. forced directed graph algorithm) is applied to each cluster sub-graph. According to some examples, graph drawing algorithm is applied to both the cluster graph and each cluster sub-graph (block 811). For example, a forced-directed or similar physical law based graph drawing algorithm can be used.

The graph drawing algorithm is applied iteratively on each cluster sub-graph and on the entire cluster graph where in each iteration of the graph drawing algorithm the cluster graph is modified from its current state to a new state.

According to an example of the presently disclosed subject matter for every iteration of the graph drawing algorithm, the cluster graph and sub-graph in each cluster node are modified as follows (block 813):

a. The size of a cluster node in the cluster graph is determined based on the two most distanced nodes in the relevant cluster sub-graph. At this point, every cluster node has a cluster sub-graph that relates to it. This is apparent from FIG. 13 where there is a cluster sub-graph of a certain category for each respective cluster node. Thus, according to one example, the perimeter (e.g. diameter) of the cluster node can be updated in each iteration based on the current distance between the two most distanced nodes in that cluster sub-graph.

b. The arrangement of each cluster sub-graph inside the relevant cluster node in the cluster graph is updated as a result of the graph drawing algorithm. According to one example, linear transformation is used for transforming the graph layout in one world, resulting from the graph drawing algorithm, to the restricted world inside each respective cluster node, confined by its perimeter.

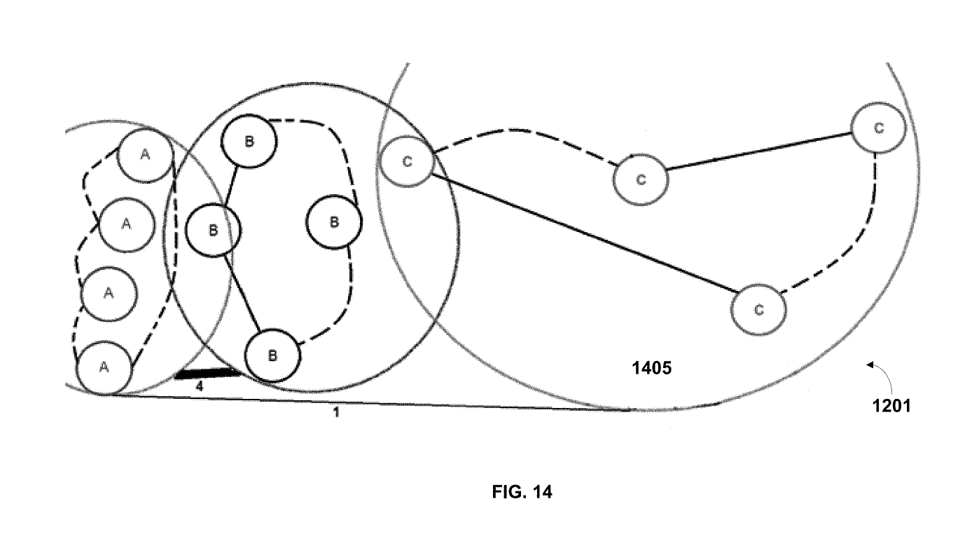

FIG. 14 is a schematic illustration showing the graph layout (intermediate graph layout) resulting from the operation described with reference to blocks 811 and 813. Note that the size of the cluster graphs nodes depends on the distance between the two most distanced nodes in the respective cluster sub-graph. In the illustrated example, cluster sub-graph 1305 (comprising nodes assigned to category C) has nodes located at the greatest distance, and accordingly the size of the respective cluster graph node (1405) is also the largest of all three nodes.

The operations of block 811 and 813 are repeated until the arrangement of the nodes of each cluster sub-graph inside each cluster node and the entire cluster graph reach a desirable state and the desired multi-variant graph layout is achieved. The number of iterations can be predefined and/or can be modified by a user before or during runtime.

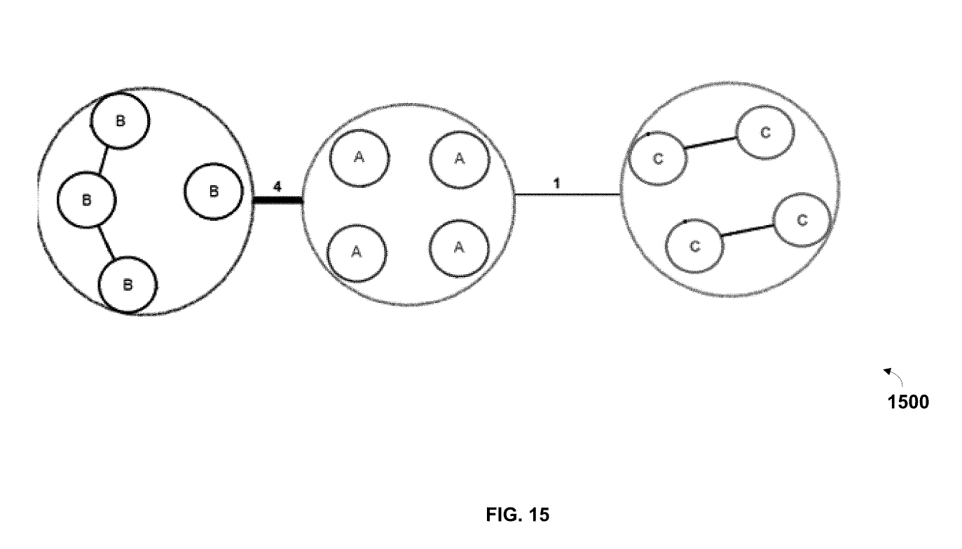

FIG. 15 is a schematic illustration showing the final (multi-variant) graph layout. FIG. 15 shows the graph resulting from the application of graph drawing algorithm. Each cluster node in the final graph comprises the respective group of nodes assigned to the same category which show their intra-connections (i.e. connections between nodes within cluster nodes, which were made by the user). Notably, in the example illustrated in FIG. 15, the “virtual edges” which were added for connecting nodes in each sub-graph are not displayed. The connecting lines (edges) which are displayed are those added by the user during construction of the customized data-base and represent actual relationships between data objects.

Furthermore, connecting lines between different cluster nodes can also be indicative of the number of inter-connections (i.e. connections between diverse node-pairs comprising nodes assigned to different categories). This can be done for example, by displaying a number indicating the number of inter-connections and/or by drawing the width of the connecting line according to the number of connections, (e.g. the greater the number of inter-connections, the greater the width of the respective connecting line) or by any other type of graphical representation.

Notably, in some cases none of the nodes in the initial graph which are assigned to a certain category are connected to nodes assigned to another category (this type of category is referred herein as “secluded category”). In such cases, there will not be an edge connecting between the cluster nodes of the secluded category and other cluster nodes of other categories. The cluster node of the secluded category will remain separated from other cluster nodes and will eventually settle based on the principles of the graph drawing algorithm which are applied on the entire cluster graph.

The final graph layout can then be rendered and displayed on a display device (block 815). The final graph provides the visualization of metadata characterizing different tables in a customized database. Assuming for the sake of example, categories A, B and C represent different ranges of values of the frequency of access requests to different tables, the final graph shows the access frequency of each table and also maintains the original connections between the tables. The final graph can be drawn using different graphic design elements to indicate different categories of each cluster node. For example, different cluster nodes can have different names, colors, sizes, texture depending on the respective category values. For instance, nodes assigned to a category having greater values (e.g. greater storage space consumption) are drawn with a greater perimeter.

The data (e.g. table content) in each table can remain associated with each respective node. The user can request the representation of one or more of the tables represented by nodes in the graph. For example, a graphical user interface (140) can be configured as an interactive display where the user can interact with nodes in the displayed final graph (e.g. by mouse click or mouse hover) and in response the relevant data is displayed on the screen. If the user interacts with a cluster node, specific metadata categories and values can be displayed on the screen and if the user interacts with a cluster sub-graph node within a cluster node, the data (e.g. table) is displayed on the screen.

As operations described above with reference to blocks 811 and 813 are iterative, the graph rendering process can be visualized as it occurs, where in each iteration the arrangement of the nodes of the graph move further into the desired layout state. This allows a user to watch the arrangement of the graph in real-time and to monitor the evolution of the cluster sub-graphs and cluster graph towards the final state. In some examples, the user can determine when the graph layout is satisfactory and stop the iterative operations accordingly.

In addition to the above, the system and method disclosed herein enable to generate a multi-variant graph in a manner which allows making changes to the final graph while maintaining the graph layout and avoiding significant degradation in system performance. Addition or removal of nodes from a final graph requires similar operations to those described above with reference to FIG. 8. However, it is disclosed herein to apply these operations only to a restricted area in the final graph and not to the entire graph. According to one example, the restricted area includes: the modified cluster sub-graph of the modified node (i.e. the node which is being added or removed), the cluster node of the modified node (which can change in size based on modification in the cluster sub-graph) and cluster nodes in the final graph which are immediately connected by an edge to modified node (which can change their relative position). Thus, according to this approach during addition or removal of nodes, not all nodes in the final graph take part in the process and accordingly performance degradation of the system during addition/removal of a modified node is reduced.

FIG. 16 is a flowchart of operations performed during addition of a node to a final graph, according to some examples of the presently disclosed subject matter. Addition or removal of nodes can be done for example by a user interacting with data management unit 105. For instance, the user can generate instructions for importing a new table and connecting the table to existing tables (represented by nodes) in the final graph. Likewise, the user can select an existing node and generate instructions to delete that node from the final graph. Responsive to an instruction to add or remove a node from the final graph, the following update process can be executed (e.g. by graph update module 138 in data management unit 105).

For the sake of example, assume a new data object (e.g. table) has been added to the final graph illustrated in FIG. 15 above where the new node is connected to one node assigned to category A and a second node assigned to category B.

An added node can belong to one of the existing categories, in which case it should be added to the relevant existing cluster node in the final graph. Alternatively, an added node can belong to a new, currently non-existing category. At block 1601 it is determined to which category of a given metadata type the new node should be assigned. This can be done based on the relevant metadata and based on categorization rules as explained above.

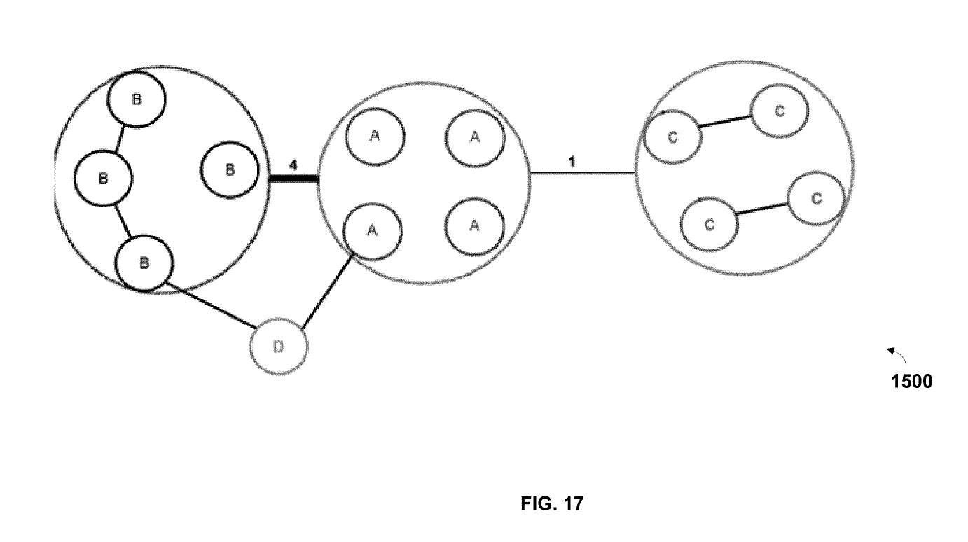

At block 1603 it is determined which nodes in the final graph are connected to the new node. This can be determined, for example, based on the connections made by the user when adding the nodes. FIG. 17 is a schematic illustration showing the connections between the new node and the existing nodes (in this case node residing in cluster node A and cluster node B). Notably, the user has connected a new node of category D, to one node in category A and another node in category B.

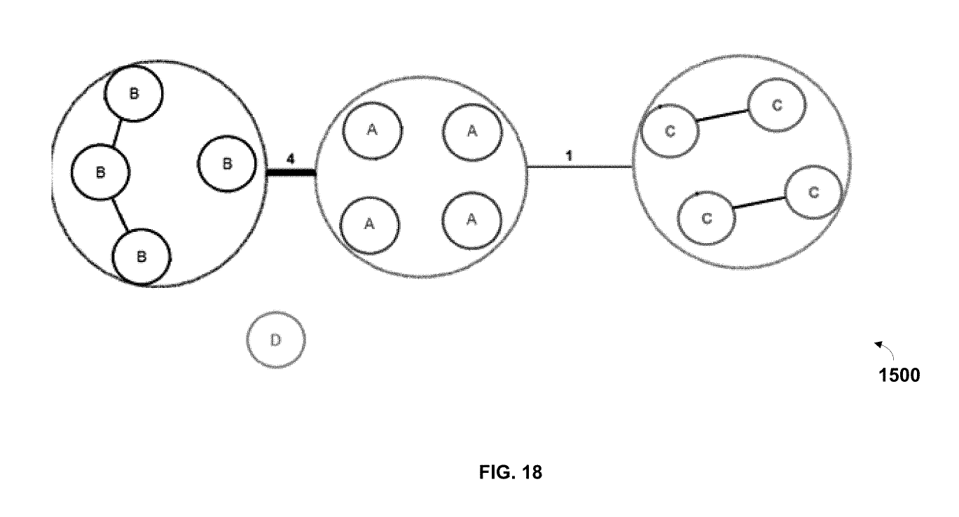

At block 1605 edges connecting the new node with existing nodes assigned to a different category (i.e. diverse node pair) are recorded and then deleted. FIG. 18 is a schematic illustration showing the final graph 1500 with the deleted edges.

At block 1607 it is determined whether there is an existing cluster node to which the new node can be added. If the new node belongs to one of the existing sub-graphs, the process continues to block 1613 described below. Otherwise if it does not, the process proceeds to block 1609.

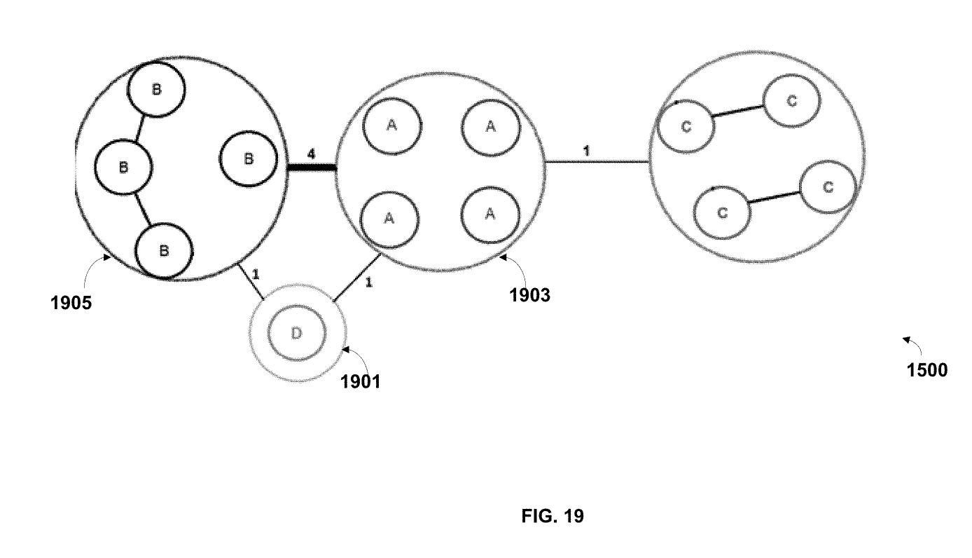

At block 1609 a new cluster node is created for the new category of the new node. The new cluster node is connected to existing cluster nodes assigned to the categories of the nodes which where originally connected to the new node (before being deleted according to block 1605 above). FIG. 19 is a schematic illustration showing the edges added between the new cluster node (1901) and existing cluster nodes (1903, 1905). Note that, as exemplified above, the number of connections can be graphically visualized e.g. by a number denoted on the edges (in this case 1).

At block 1611 a graph drawing algorithm (e.g. force-directed graph drawing algorithm) is applied to a restricted area of the graph. Since the new cluster sub-graph contains only one node (i.e. the new node added to the graph) it is unnecessary to run the drawing algorithm on the cluster sub-graph of the new cluster node. Therefore, graph drawing algorithm is applied to the cluster node of the modified (in this case added) node and the cluster nodes which are immediately connected by an edge to a modified node for updating the layout of this part of the cluster graph.

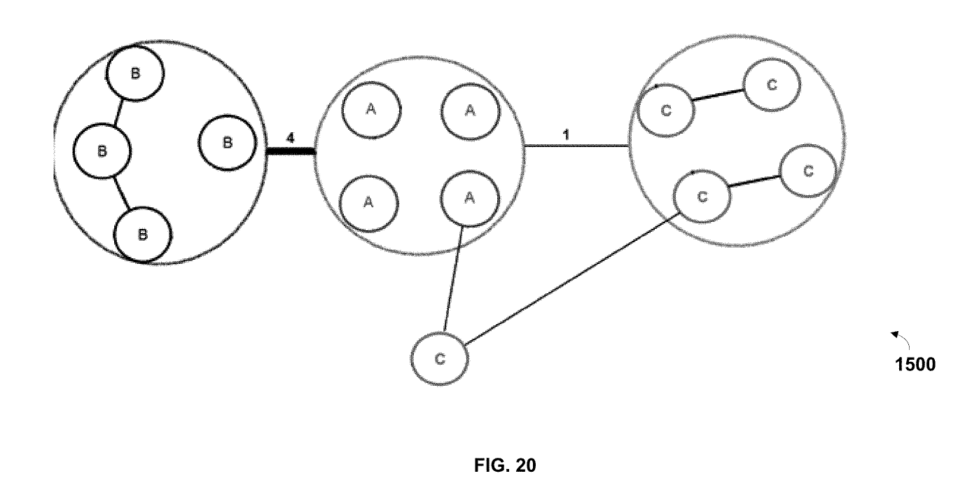

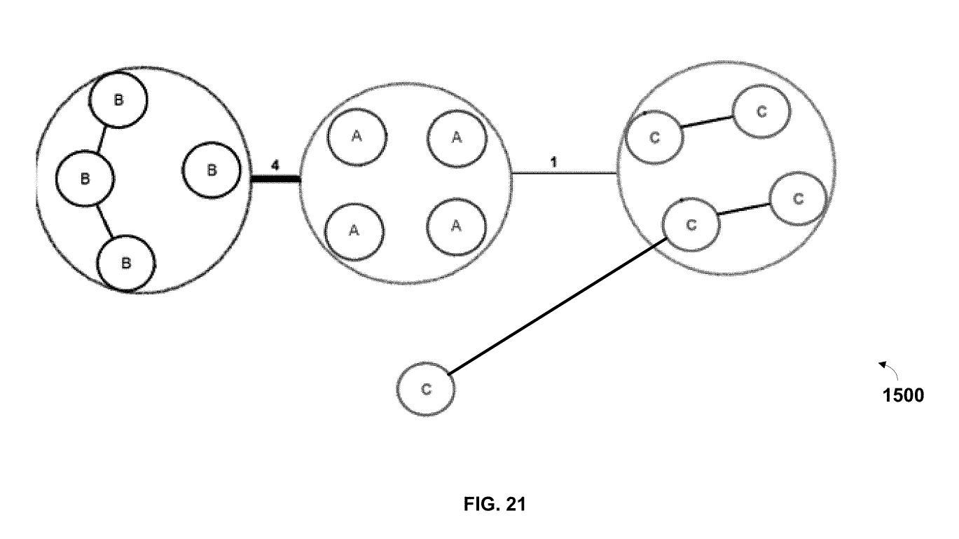

Turning to block 1613, this illustrates operations performed in the event that the new node belongs to one of the existing sub-graphs in one of the existing cluster nodes. Starting from the final graph shown in FIG. 15, FIG. 20 is a schematic illustration showing the connections between the new node and the existing nodes (in this case nodes residing in cluster node of category A and in cluster node of category C). As explained above with reference to block 1605, FIG. 21 is a schematic illustration showing the final graph 1500 after the edge between the new node and cluster A has been recorded and deleted. Note, that as the new node belongs to category C, the line connecting the new node with a node in category C is not deleted.

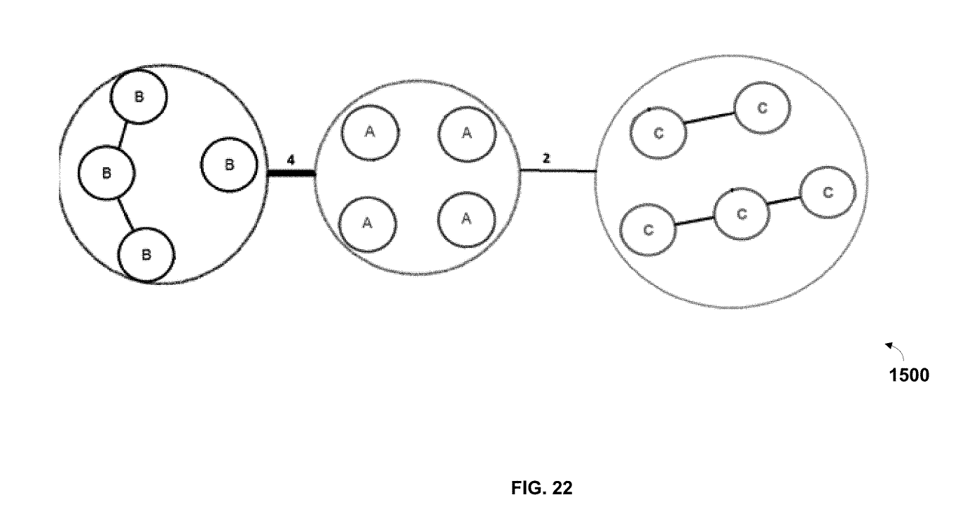

At block 1613 the new node is added to the existing cluster node assigned to the same category (in this case C). As an additional diverse node-pair between category A and category C was added the diverse node-pair counter is updated to indicate this change. FIG. 22 shows the new node within the cluster node. Note that the counter between cluster A and cluster C has been incremented by one to indicate the additional diverse node-pair between the two cluster nodes.

At block 1615 a graph drawing algorithm (e.g. force-directed graph drawing algorithm) is applied to the cluster sub-graph within the updated cluster node and also to the updated cluster node and cluster nodes immediately connected to the updated cluster node. For each iteration of the graph drawing algorithm the following can be performed:

a. The size of the updated cluster node is updated based on the two most distanced nodes in the updated cluster sub-graph—resulting from the graph drawing algorithm applied on the cluster sub-graph.

b. The arrangement of the cluster sub-graph inside the updated cluster node is updated as a result of the graph drawing algorithm. As explained above, linear transformation can be used for transforming any changes in the sub-graph layout to the restricted world inside the cluster node.

The same principles described above with respect to node addition are likewise applicable to node deletion, mutatis mutandis.

As mentioned above and as evident from the above description, the operations described above with reference to block 1617 are performed only on the restricted part of the final graph, where other parts of the final graph remain unchanged. As a result, any performance degradation affects only the restricted area and not the entire graph. This provides a significant advantage over other methods which require, for the addition and/or deletion of nodes, to run the algorithm on the entire graph. The significance of this advantage increases with the size of the graph (as the graph grows in size the ratio between the size of the restricted area and the size of the entire graph increases). Notably, if an added node is assigned to a new, previously non-existing category, fewer operations are performed as compared to adding a node of an existing category.

It is to be understood that the system according to the presently disclosed subject matter may be a suitably programmed computer. Likewise, the presently disclosed subject matter contemplates a non-transitory computer program being readable by a computer for executing the method of the presently disclosed subject matter. The presently disclosed subject matter further contemplates a machine-readable memory (transitory and non-transitory) tangibly embodying a program of instructions executable by the machine for executing the method of the presently disclosed subject matter.

It is also to be understood that the presently disclosed subject matter is not limited in its application to the details set forth in the description contained herein or illustrated in the drawings. The presently disclosed subject matter is capable of other embodiments and of being practiced and carried out in various ways. For example, while a data warehouse system is described hereinabove, this is done in a non-limiting manner and the principles of the presently disclosed subject matter can be likewise implemented in other types of database systems. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. A computer implemented method of generating a graph layout for collectively visualizing both graph data and graph metadata on a computer display device; the computer comprising at least one computer processor; the method comprising operating the at least one computer processor for:
obtaining an initial graph comprising two or more nodes, wherein at least two nodes in the initial graph are connected by an edge; wherein nodes in the initial graph represent respective data objects and have metadata associated therewith and are assigned to a respective category based on respective metadata values of the node;
recording the number of each different type of diverse node-pair and deleting edges between diverse node pairs; wherein a diverse node pair includes two connected nodes, each node assigned to a different category;
generating a cluster-graph; the cluster graph comprising a cluster node for each category of nodes in the diverse-node pairs and an edge connecting any two cluster nodes representing a respective diverse node pair;
generating a cluster sub-graph connecting all nodes in the initial graph which are assigned to the same category;
assigning each cluster sub-graph to a respective cluster node in the cluster graph;
applying a graph drawing algorithm on each cluster sub-graph;
rendering a final graph comprising the cluster graph and a cluster sub-graph within each respective cluster node of the cluster graph; wherein cluster nodes graphically indicate respective metadata and nodes in each cluster sub-graph graphically indicate respective data.

2. The method of claim 1 further comprising: applying a graph drawing algorithm on the cluster graph.

3. The method of claim 1 wherein generating a cluster sub-graph further comprises:
adding virtual edges connecting between all nodes assigned to the same category.

4. The method of claim 3 wherein the virtual edges are not displayed on the displayed device and remain hidden from the eyes of the user.

5. The method of claim 3 wherein rendering a final graph comprises:
iteratively applying the graph drawing algorithm on each cluster sub-graph, and for each iteration:
determining distance between two most distanced nodes in each cluster sub-graph; and
updating perimeter of a respective cluster node based on the distance.

6. The method of claim 5 wherein rendering the final graph further comprises:
applying linear transformation for transforming the graph layout of each cluster sub-graph resulting from the graph drawing algorithm to a respective graph layout adapted to the world confined by the perimeter of a respective cluster node.

7. The method of claim 1 wherein determining distance between two most distanced nodes in each cluster sub-graph comprises applying a minimum spanning tree algorithm on the cluster sub-graph.

8. The method of claim 1 wherein the graph drawing algorithm is a force directed graph algorithm.

9. The method of claim 1 further comprising displaying the final graph on a computer display device.

10. The method of claim 1 wherein rendering the final graph comprises:
graphic visualization with respect to an edge connecting two cluster nodes, of information pertaining to the number of diverse node pairs.

11. The method of claim 1 wherein rendering the final graph comprises:
rendering each cluster node using one or more graphic design elements to indicate the respective metadata category of the cluster node.

12. The method of claim 1 wherein each node in each cluster sub-graph is linked to a respective data object, the method further comprising: graphically displaying data pertaining to the respective data object responsive to user interaction with the given node.

13. The method of claim 5 further comprising:
for each iteration, updating the cluster graph and the cluster sub-graph in each cluster node and graphically displaying on a computer display the updated cluster graph and updated cluster sub-graphs thereby visualizing in real-time changes to the cluster graph until it reaches a state of the final graph.

14. The method of claim 1 wherein an addition or a deletion of a node from the final graph involves application of operations only with respect to a restricted area of the final graph.

15. The method of claim 14 wherein the restricted area comprises: a respective cluster sub-graph to which the node is related, a cluster node comprising the respective cluster graph and any cluster node immediately connected to the cluster node; thereby limiting performance degradation resulting from addition or deletion of a node.

16. The method of claim 14 wherein adding a new node to the graph comprises:
assigning the new node to a respective category;
connecting the new node to an existing cluster sub-graph of the respective category;
applying a graph drawing algorithm to the existing cluster sub-graph; a respective cluster node of the existing cluster sub-graph and to cluster nodes immediately connected to the respective cluster node.

17. The method of claim 1 wherein the metadata pertains to a plurality of metadata types, the method comprising, calculating a compiled metadata value based on the values of the plurality of metadata types.

18. The method of claim 1 wherein the data object is a table comprising business intelligence information.

19. A computer-implemented system of generating a graph layout for collectively visualizing both graph data and graph metadata on a computer display device; the system comprising at least one computer processor operatively connected to a computer memory; the at least one computer processor being configured, responsive to instructions loaded on the computer memory, to:
assign each node in an initial graph to a respective category based on respective metadata values of the node; wherein the initial graph comprises two or more nodes, wherein at least two nodes in the initial graph are connected by an edge; wherein nodes in the initial graph represent respective data objects and have metadata associated therewith;
record the number of each different type of diverse node-pair and deleting edges between diverse node pairs; wherein a diverse node pair includes two connected nodes, each node assigned to a different category;
generate a cluster-graph; the cluster graph comprising a cluster node for each category of nodes in the diverse-node pairs and an edge connecting any two cluster nodes representing respectively a respective diverse node pair; generate a cluster sub-graph connecting all nodes in the initial graph which are assigned to the same category;
assign each cluster sub-graph to a respective cluster node in the cluster graph;
apply a graph drawing algorithm on each cluster sub-graph;
render a final graph comprising the cluster graph and a cluster sub-graph within each respective cluster node of the cluster graph; wherein cluster nodes graphically indicate respective metadata and nodes in each cluster sub-graph graphically indicate respective data.

20. The system of claim 19 wherein the at least one processor is further configured to apply a graph drawing algorithm on the cluster graph.

21. The system of claim 19 wherein the at least one computer processor is further configured for generating a cluster sub-graph, to:
add virtual edges connecting between all nodes assigned to the same category.

22. The system of claim 21 wherein the virtual edges are not displayed on the displayed device and remain hidden from the eyes of the user.

23. The system of claim 22 wherein the at least one computer processor is configured for rendering a final graph to:
iteratively apply the graph drawing algorithm on each cluster sub-graph, and for each iteration:
determine distance between two most distanced nodes in each cluster sub-graph; and
update perimeter of a respective cluster node based on the distance.

24. The system of claim 23 wherein the at least one computer processor is further configured for rendering a final graph to:
apply linear transformation for transforming the graph layout of each cluster sub-graph resulting from the graph drawing algorithm to a respective graph layout adapted to the world confined by the perimeter of a respective cluster node.

25. The system of claim 19 wherein the at least one computer processor is configured for determining distance between two most distanced nodes in each cluster sub-graph, to apply a minimum spanning tree algorithm on the cluster sub-graph.

26. The system of claim 19 further comprising a computer display device and wherein the at least one computer processor is configured to display the final graph on the computer display device.

27. The system of claim 19 wherein the at least one computer processor is configured for rendering a final graph to: graphically visualize, with respect to an edge connecting two cluster nodes, information pertaining to the number of diverse node pairs.

28. The system of claim 19 wherein the at least one computer processor is configured for rendering a final graph to: render each cluster node using one or more graphic design elements to indicate the respective metadata category of the cluster node.

29. The system of claim 19 wherein each node in each cluster sub-graph is linked to a respective data object, the at least one computer processor is further configured to: graphically display data pertaining to the respective data object responsive to user interaction with the given node.

30. The system of claim 23 wherein the at least one computer processor is configured to:
for each iteration, update the cluster graph and the cluster sub-graph in each cluster node and graphically display on a computer display the updated cluster graph and updated cluster sub-graphs thereby visualizing in real-time changes to the cluster graph until it reaches a state of the final graph.

31. The system of claim 19 wherein an addition or deletion of a node from the final graph involves application of operation only with respect to a restricted area of the final graph.

32. The system of claim 31 wherein the at least one computer processor is configured for adding a new node to the graph to:
assign the new node to a respective category;
connect the new node to an existing cluster sub-graph of the respective category;
apply a graph drawing algorithm to: the existing cluster sub-graph; a respective cluster node of the existing cluster sub-graph; and to cluster nodes immediately connected to the respective cluster node.

33. A non-transitory program storage device readable by machine, tangibly embodying a program of instructions executable by the machine to perform a method of generating a graph layout for collectively visualizing both graph data and graph metadata on a computer display device; the computer comprising at least one computer processor; the method comprising:
obtaining an initial graph comprising two or more nodes, wherein at least two nodes in the initial graph are connected by an edge; wherein nodes in the initial graph represent respective data objects and have metadata associated therewith;
assigning each node in the initial graph to a respective category based on respective metadata values of the node;
recording the number of each different type of diverse node-pair and deleting edges between diverse node pairs; wherein a diverse node pair includes two connected nodes, each node assigned to a different category;
generating a cluster-graph; the cluster graph comprising a cluster node for each category of nodes in the diverse-node pairs and an edge connecting any two cluster nodes representing respectively a respective diverse node pair;
generating a cluster sub-graph connecting all nodes in the initial graph which are assigned to the same category;
assigning each cluster sub-graph to a respective cluster node in the cluster graph;
applying a graph drawing algorithm on each cluster sub-graph;
rendering a final graph comprising the cluster graph and a cluster sub-graph within each respective cluster node of the cluster graph; wherein cluster nodes graphically indicate respective metadata and nodes in each cluster sub-graph graphically indicate respective data.
